(19) United States
(12) Patent Application Publication
(10) Pub. No.: US 2026/0088408 A1
(43) Pub. Date: Mar. 26, 2026

(54) BATTERY CELL WITH MULTIPLE STACKS

(71) Applicant: Apple Inc., Cupertino, CA (US)

(72) Inventors: Hirotsugu Oba, Sunnyvale, CA (US); Ramachandran Subbaraman, Cupertino, CA (US); Brian K. Shiu, Sunnyvale, CA (US); Rui Liu, Mountain View, CA (US); Patrick Okimi, Cupertino, CA (US)

(21) Appl. No.: 19/335,593

(22) Filed: Sep. 22, 2025

Related U.S. Application Data
(60) Provisional application No. 63/698,224, filed on Sep. 24, 2024.

(51) Int. Cl. H01M 50/178; H01M 10/42; H01M 50/105; H01M 50/119; H01M 50/474

(52) U.S. Cl. CPC H01M 50/178; H01M 10/425; H01M 50/105; H01M 50/119; H01M 50/474; H01M 2010/4271; H01M 2220/30

(57) ABSTRACT

Aspects of the present disclosure involve battery cells divided into multiple stacks. A battery pack includes an enclosure enclosing a battery cell, and at least one insulator dividing the battery cell into a first stack and a second stack. A first pair of tabs extends from the first stack through the enclosure. The first pair of tabs comprises a first tab coupled to a cathode layer of the first stack and a second tab coupled to an anode layer of the first stack. A second pair of tabs extends from the second stack through the enclosure. The second pair of tabs comprises a third tab coupled to a cathode layer of the second stack and a fourth tab coupled to an anode layer of the second stack. The first tab is connected to the fourth tab to connect the first stack and the second stack in a series configuration.

### PRIORITY

The disclosure claims the benefit under 35 U.S.C. § 119 (e) of U.S. Provisional Patent Application No. 63/698,224 entitled “Battery Cell with Multiple Stacks”, filed on Sep. 24, 2024, which is incorporated herein by reference in its entirety.

### TECHNICAL FIELD

This disclosure relates generally to battery packs, and more specifically to battery packs including a single battery cell having multiple stacks.

### BACKGROUND

Many devices, such as portable electronic devices, require multiple battery cells to sufficiently power the device components. However, ensuring that multiple battery cells can fit within an allotted space in a device is a continual challenge. Further, utilizing multiple battery cells in a single device can result in a significant loss of energy within the device. It is with these and other issues in mind that various aspects of the present disclosure were developed.

### SUMMARY

In one aspect, the disclosure is directed to a battery pack that includes a single battery cell enclosed by an enclosure. The battery pack can include at least one insulator that divides the single battery cell into a first stack and a second stack. The first stack and the second stack can each comprise a cathode layer, an anode layer, and a separator layer disposed between the cathode layer and the anode layer. The battery pack can include a first pair of conductive tabs extending from the first stack and through the enclosure. The first pair of conductive tabs can include a first tab coupled to the cathode layer of the first stack and a second tab coupled to the anode layer of the first stack. The battery pack can include a second pair of conductive tabs extending from the second stack and through the enclosure. The second pair of conductive tabs can include a third tab coupled to the cathode layer of the second stack and a fourth tab coupled to the anode layer of the second stack. The first tab can be configured to be connected to the fourth tab to connect the first stack and the second stack in a series configuration. The second tab and the third tab can be configured to be connected to at least one component of a portable electronic device.

In a further aspect, the disclosure is directed to a portable electronic device including a battery pack, at least one component, and a battery management unit (BMU) configured to provide power from the battery pack to the at least one component. The battery pack can include a single battery cell enclosed by an enclosure. The battery pack can include at least one insulator that divides the single battery cell into a first stack and a second stack. The first stack and the second stack can each comprise a cathode layer, an anode layer, and a separator layer disposed between the cathode layer and the anode layer. The battery pack can include a first pair of conductive tabs extending from the first stack and through the enclosure. The first pair of conductive tabs can include a first tab coupled to the cathode layer of the first stack and a second tab coupled to the anode layer of the first stack. The battery pack can include a second pair of conductive tabs extending from the second stack and through the enclosure. The second pair of conductive tabs can include a third tab coupled to the cathode layer of the second stack and a fourth tab coupled to the anode layer of the second stack. The first tab can be configured to be connected to the fourth tab to connect the first stack and the second stack in a series configuration. The second tab and the third tab can be configured to be connected to the BMU to provide power from the battery pack to the at least one component.

### BRIEF DESCRIPTION OF THE DRAWINGS

Although the following figures and description illustrate specific embodiments and examples, the skilled artisan will appreciate that various changes and modifications may be made without departing from the spirit and scope of the disclosure.

FIG. 1A is a cross section view of a battery pack including a single battery cell having multiple stacks; according to an illustrative embodiment;

FIG. 1B is a cross section view of a battery pack including a single battery cell having multiple stacks; according to an illustrative embodiment;

FIG. 1C is a cross section view of a battery pack including a single battery cell having multiple stacks; according to an illustrative embodiment;

FIG. 1D is a cross section view of a battery pack including a single battery cell having multiple stacks; according to an illustrative embodiment;

FIG. 1E is a cross section view of a battery pack including a single battery cell having multiple stacks; according to an illustrative embodiment;

FIG. 2A is a top view of a battery pack including a single battery cell having multiple stacks; according to an illustrative embodiment;

FIG. 2B is a top view of a battery pack including a single battery cell having multiple stacks; according to an illustrative embodiment;

FIG. 2C is a top view of a battery pack including a single battery cell having multiple stacks; according to an illustrative embodiment;

FIG. 2D is a top view of a battery pack including a single battery cell having multiple stacks; according to an illustrative embodiment;

FIG. 3 illustrates an example method for manufacturing a battery pack including a single battery cell having multiple stacks; according to an illustrative embodiment; and

FIG. 4 is a portable electronic device, according to an illustrative embodiment.

### DETAILED DESCRIPTION

As noted above, aspects of the present disclosure involve a battery pack including a single battery cell having multiple stacks. In general, the battery pack can include a single battery cell and an enclosure enclosing the single battery cell. The battery pack can include at least one insulator dividing the single battery cell into a first stack and a second stack. The first stack and the second stack can each comprise a cathode layer, an anode layer, and a separator layer disposed between the cathode layer and the anode layer. A first pair of conductive tabs can extend from the first stack and through the enclosure. The first pair of conductive tabs can include a first tab coupled to the cathode layer of the first stack and a second tab coupled to the anode layer of the first stack. A second pair of conductive tabs can extend from the second stack and through the enclosure. The second pair of conductive tabs can include a third tab coupled to the cathode layer of the second stack and a fourth tab coupled to the anode layer of the second stack. In general, the first tab can be connected to the fourth tab to connect the first stack and the second stack in a series configuration. The second tab and the third tab can be connected to at least one component of a portable electronic device, such as to a battery management unit (BMU) of the portable electronic device.

Through this particular battery pack design, several advantages may be obtained over conventional battery packs. For example, a conventional battery pack can include multiple battery cells. However, the multiple battery cells can consume valuable space within a portable electronic device. Further, the use of multiple battery cells within a portable electronic device can cause a significant loss of energy within the portable electronic device. The multiple battery cells can become out-of-balance over time, which can cause the multiple battery cells to wear and degrade at accelerated rates. By making the multiple battery cells as identical as possible, cell to cell variation, which can cause an energy density penalty, can be reduced.

The improved battery pack described herein allows for allows a series connection between multiple battery stacks within a single cell space, thereby enabling an increased run time by operating at a constant voltage mode and reducing impedance-related brown-out risks by shifting the operating voltage at the battery to higher levels. The improved battery pack described herein eliminates potential cell-to-cell imbalances faced by conventional multi-cell battery packs. Further, the improved battery pack described herein can reduce the footprint for BMU hardware, given that a BMU connected to the improved battery pack will balance a higher volumetric energy density (VED) than a BMU connected to a conventional multi-cell battery pack. Further, the improved battery pack described herein can reduce the footprint associated with flexible circuit boards that can be necessary to manage multi-cell architecture.

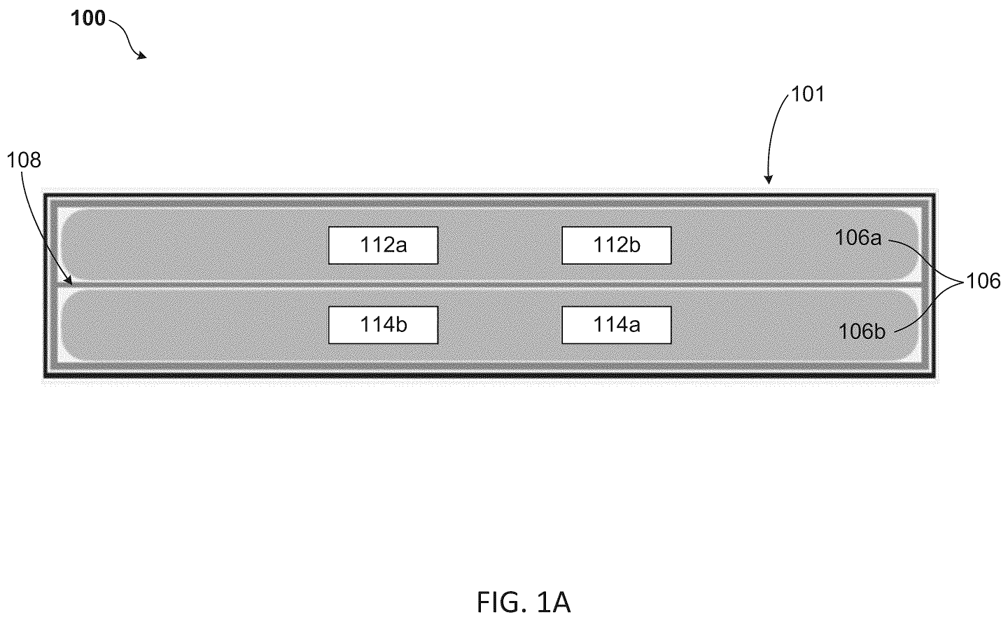

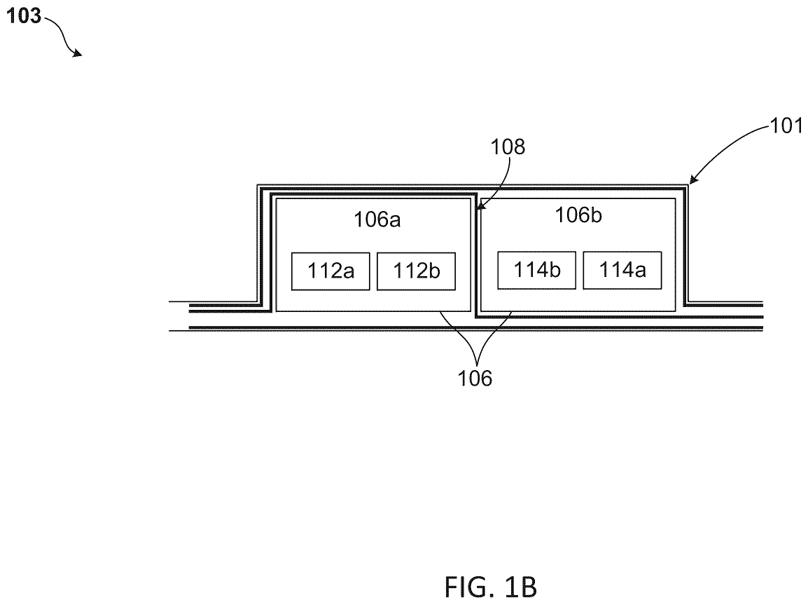

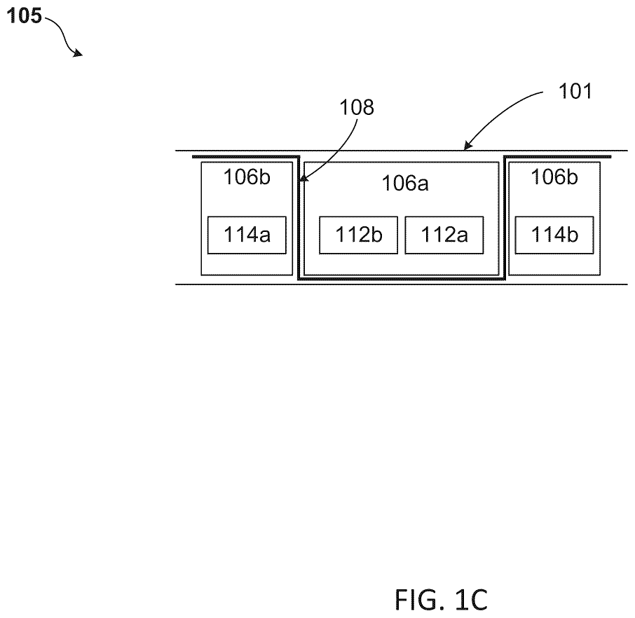

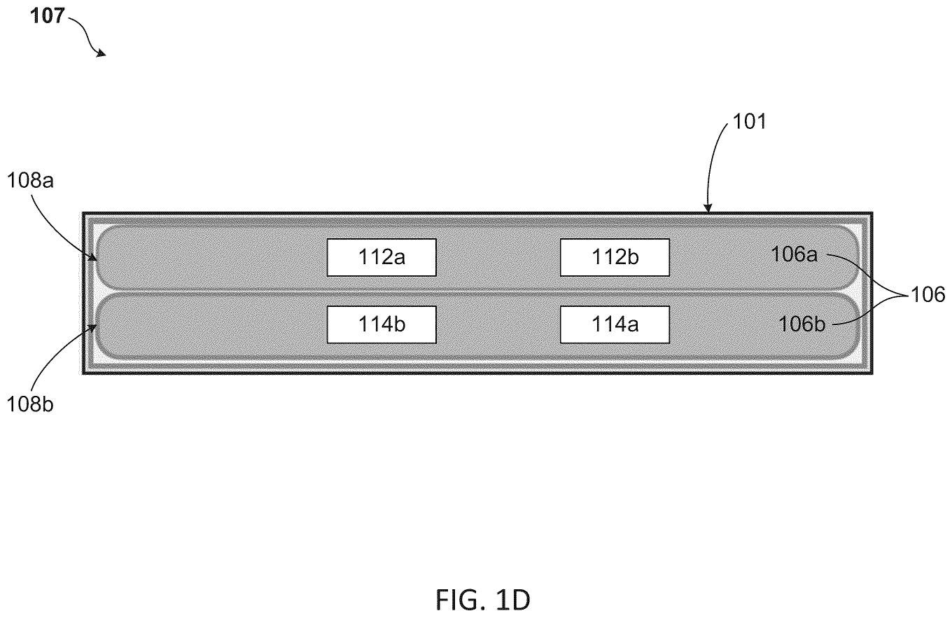

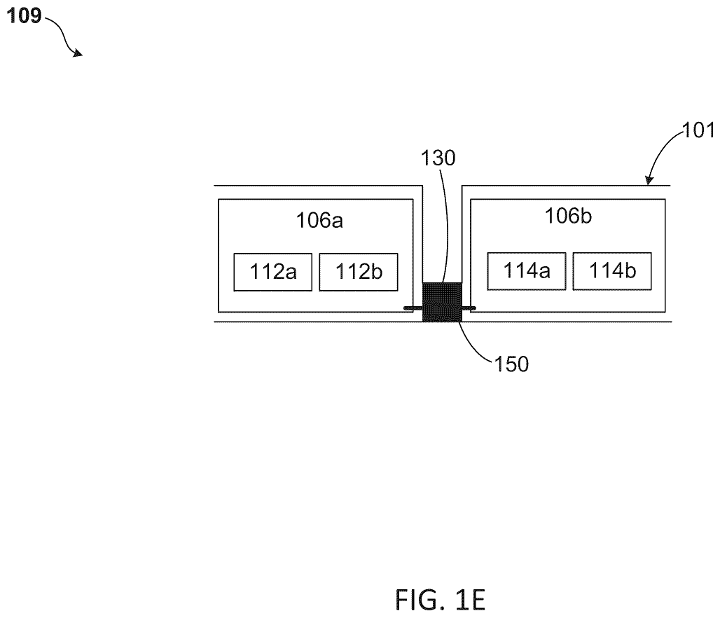

FIG. 1A is a cross section view of a battery pack 100. The battery pack 100 can include a battery cell 106 and an enclosure 101 enclosing the battery cell 106. The battery pack 100 can include at least one insulator 108 dividing the battery cell 106 into a first stack 106a and a second stack 106b. As shown in the example of FIG. 1A, the least one insulator 108 can include a single insulating divider layer that divides the enclosure 101 into a first chamber housing the first stack 106a and a second chamber housing the second stack 106b. The first stack 106a can be positioned substantially on top of the second stack 106b. The interior walls of the enclosure 101 can be further lined with insulating material.

The single insulating divider layer can include polyethylene (PE), polypropylene (PP), and/or a combination of PE and PP, such as PE/PP or PP/PE/PP. The single insulating divider layer can include any polymer material that is chemically resistant to battery electrolytes, composite layers (e.g., polymer layers sandwiching a metal foil to add mechanical robustness), and/or polymer materials reinforced with metal laminate layers. For example, the single insulating divider layer can include a polypropylene (PP) separation film. The single insulating divider layer can be heat sealed with the enclosure 101, such as with an outer layer or wall of the enclosure 101, to provide a liquid tight barrier between the two chambers. The first chamber and the second chamber can each separately be filled with an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The first stack 106a and the second stack 106b can each include a cathode layer, an anode layer, and a separator layer disposed between the cathode layer and the anode layer. For example, the cathode layer can be an aluminum foil coated with a lithium compound (e.g., LiCoO2, LINCoMn, LiCoAl or LiMn2O4) and the anode layer can be a copper foil coated with carbon or graphite. The separator layer can include polyethylene (PE), polypropylene (PP), and/or a combination of PE and PP, such as PE/PP or PP/PE/PP.

The battery pack 100 can include a first pair of conductive tabs 112a-b extending from the first stack 106a through the enclosure 101. The first pair of conductive tabs 112a-b can include a first tab 112a coupled to the cathode layer of the first stack 106a and a second tab 112b coupled to the anode layer of the first stack 106a. The battery pack 100 can include a second pair of conductive tabs 114a-b extending from the second stack 106b through the enclosure 101. The second pair of conductive tabs 112a-b can include a third tab 114a coupled to the cathode layer of the second stack 106b and a fourth tab 114b coupled to the anode layer of the second stack 106b.

In embodiments, the first tab 112a and the fourth tab 114b can extend through the enclosure 101 such that the first tab 112a and the fourth tab 114b at least partially overlap and reside in substantially separate parallel planes external to the enclosure 101. As shown in the example of FIG. 1A, the first tab 112a can reside substantially on top of the fourth tab 114b. Likewise, the second tab 112b can reside substantially on top of the third tab 114a.

In embodiments, the first tab 112a is configured to be connected to the fourth tab 114b to connect the first stack 106a and the second stack 106b in a series configuration. The second tab 112b and the third tab 114a can be configured to be connected to at least one component of an electronic device, such as to a BMU of a portable electronic device. In other embodiments, the first tab 112a is configured to be connected to the third tab 114a and the second tab 112b is configured to be connected to the fourth tab 114b to connect the first stack 106a and the second stack 106b in a parallel configuration. The first tab 112a and the fourth tab 114b can be configured to be connected to at least one component of an electronic device, such as to a BMU of a portable electronic device.

The enclosure 101 can have any shape or size, giving the battery pack 100 substantial form factor flexibility. For example, the enclosure 101 can be formed to fit within a prescribed area within a device, such as a portable electronic device. This form can include any number of sides, angles, and/or shapes to account for one or more other components within the device. However, any shape or size of the enclosure 101 is contemplated.

In embodiments, the enclosure 101 includes a flexible pouch. such as a pouch formed by folding a flexible sheet along a fold line. In some instances, the flexible sheet is made of aluminum with a polymer film, such as polypropylene. After the flexible sheet is folded, the flexible sheet can be sealed, for example, by applying heat along a side seal and along a terrace seal. The flexible pouch may be less than or equal to 120 microns thick to improve the packaging efficiency of the battery pack 100, the density of battery pack 100, or both.

In embodiments the enclosure 101 may be formed of a rigid material, such as a metal alloy which may, for example, include stainless steel, aluminum, aluminum alloy, or other sufficiently rigid materials as would be known by a person of ordinary skill in the art. The enclosure 101 can have a non-corrosive coating line the interior of the enclosure 101. The enclosure 101 can have a cylindrical shape, cuboid shape, prism shape, conical shape, pyramid shape, L-shape, combinations thereof, or some other shape.

FIG. 1B is a cross section view of a battery pack 103. The battery pack 103 can include the battery cell 106 and the enclosure 101 enclosing the battery cell 106. The battery pack 103 can include the at least one insulator 108 dividing the battery cell 106 into the first stack 106a and the second stack 106b. As shown in the example of FIG. 1B, the least one insulator 108 can extend over the stack 106a, between the stack 106a, and under the stack 106b to divide the enclosure 101 into a first chamber housing the first stack 106a and a second chamber housing the second stack 106b. The first stack 106a can be positioned substantially adjacent to the second stack 106b. The interior walls of the enclosure 101 can be further lined with insulating material.

The least one insulator 108 can include polyethylene (PE), polypropylene (PP), and/or a combination of PE and PP, such as PE/PP or PP/PE/PP. For example, the single insulating divider layer can include a polypropylene (PP) separation film. The at least one insulator 108 can include any polymer material that is chemically resistant to battery electrolytes, composite layers (e.g., polymer layers sandwiching a metal foil to add mechanical robustness), and/or polymer materials reinforced with metal laminate layers.

The single insulating divider layer can be heat sealed with the enclosure 101, such as with an outer layer or wall of the enclosure 101, to provide a liquid tight barrier between the two chambers. The first chamber and the second chamber can each separately be filled with an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The first stack 106a and the second stack 106b can each include a cathode layer, an anode layer, and a separator layer disposed between the cathode layer and the anode layer. For example, the cathode layer can be an aluminum foil coated with a lithium compound (e.g., LiCoO2, LINCoMn, LiCoAl or LiMn2O4) and the anode layer can be a copper foil coated with carbon or graphite. The separator layer can include polyethylene (PE), polypropylene (PP), and/or a combination of PE and PP, such as PE/PP or PP/PE/PP.

The battery pack 103 can include a first pair of conductive tabs 112a-b extending from the first stack 106a through the enclosure 101. The first pair of conductive tabs 112a-b can include a first tab 112a coupled to the cathode layer of the first stack 106a and a second tab 112b coupled to the anode layer of the first stack 106a. The battery pack 103 can include a second pair of conductive tabs 114a-b extending from the second stack 106b through the enclosure 101. The second pair of conductive tabs 112a-b can include a third tab 114a coupled to the cathode layer of the second stack 106b and a fourth tab 114b coupled to the anode layer of the second stack 106b.

In embodiments, the first tab 112a and the fourth tab 114b can extend through the enclosure 101 such that the first tab 112a and the fourth tab 114b both substantially reside in a single plane external to the enclosure.

In embodiments, the first tab 112a is configured to be connected to the fourth tab 114b to connect the first stack 106a and the second stack 106b in a series configuration. The second tab 112b and the third tab 114a can be configured to be connected to at least one component of an electronic device, such as to a BMU of a portable electronic device. In other embodiments, the first tab 112a is configured to be connected to the third tab 114a and the second tab 112b is configured to be connected to the fourth tab 114b to connect the first stack 106a and the second stack 106b in a parallel configuration. The first tab 112a and the fourth tab 114b can be configured to be connected to at least one component of an electronic device, such as to a BMU of a portable electronic device.

The enclosure 101 can have any shape or size, giving the battery pack 103 substantial form factor flexibility. For example, the enclosure 101 can be formed to fit within a prescribed area within a device, such as a portable electronic device. This form can include any number of sides, angles, and/or shapes to account for one or more other components within the device. However, any shape or size of the enclosure 101 is contemplated.

In embodiments, the enclosure 101 includes a flexible pouch. such as a pouch formed by folding a flexible sheet along a fold line. In some instances, the flexible sheet is made of aluminum with a polymer film, such as polypropylene. After the flexible sheet is folded, the flexible sheet can be sealed, for example, by applying heat along a side seal and along a terrace seal. The flexible pouch may be less than or equal to 120 microns thick to improve the packaging efficiency of the battery pack 103, the density of battery pack 103, or both.

In embodiments the enclosure 101 may be formed of a rigid material, such as a metal alloy which may, for example, include stainless steel, aluminum, aluminum alloy, or other sufficiently rigid materials as would be known by a person of ordinary skill in the art. The enclosure 101 can have a non-corrosive coating line the interior of the enclosure 101. The enclosure 101 can have a cylindrical shape, cuboid shape, prism shape, conical shape, pyramid shape, L-shape, combinations thereof, or some other shape.

FIG. 1C is a cross section view of a battery pack 105. The battery pack 105 can include the battery cell 106 and the enclosure 101 enclosing the battery cell 106. The battery pack 105 can include the at least one insulator 108 dividing the battery cell 106 into the first stack 106a and the second stack 106b. As shown in the example of FIG. 1C, the least one insulator 108 can extend over a first portion of the stack 106b, between the first portion of the stack 106b and the stack 106a, under the stack 106a, between a second portion of the stack 106b and the stack 106a, and over the second portion of the stack 106b to divide the enclosure 101 into a first chamber housing the first stack 106a and a second chamber housing the second stack 106b. The first stack 106a can be positioned substantially adjacent to the first and second portions of the second stack 106b. The interior walls of the enclosure 101 can be further lined with insulating material.

The least one insulator 108 can include polyethylene (PE), polypropylene (PP), and/or a combination of PE and PP, such as PE/PP or PP/PE/PP. For example, the single insulating divider layer can include a polypropylene (PP) separation film. The at least one insulator 108 can include any polymer material that is chemically resistant to battery electrolytes, composite layers (e.g., polymer layers sandwiching a metal foil to add mechanical robustness), and/or polymer materials reinforced with metal laminate layers. The single insulating divider layer can be heat sealed with the enclosure 101, such as with an outer layer or wall of the enclosure 101, to provide a liquid tight barrier between the two chambers. The first chamber and the second chamber can each separately be filled with an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The first stack 106a and the second stack 106b can each include a cathode layer, an anode layer, and a separator layer disposed between the cathode layer and the anode layer. For example, the cathode layer can be an aluminum foil coated with a lithium compound (e.g., LiCoO2, LiNCoMn, LiCoAl or LiMn2O4) and the anode layer can be a copper foil coated with carbon or graphite. The separator layer can include polyethylene (PE), polypropylene (PP), and/or a combination of PE and PP, such as PE/PP or PP/PE/PP.

The battery pack 105 can include a first pair of conductive tabs 112a-b extending from the first stack 106a through the enclosure 101. The first pair of conductive tabs 112a-b can include a first tab 112a coupled to the cathode layer of the first stack 106a and a second tab 112b coupled to the anode layer of the first stack 106a. The battery pack 105 can include a second pair of conductive tabs 114a-b extending from the second stack 106b through the enclosure 101. The second pair of conductive tabs 112a-b can include a third tab 114a coupled to the cathode layer of the second stack 106b and a fourth tab 114b coupled to the anode layer of the second stack 106b.

In embodiments, the first tab 112a and the fourth tab 114b can extend through the enclosure 101 such that the first tab 112a and the fourth tab 114b both substantially reside in a single plane external to the enclosure.

In embodiments, the first tab 112a is configured to be connected to the fourth tab 114b to connect the first stack 106a and the second stack 106b in a series configuration. The second tab 112b and the third tab 114a can be configured to be connected to at least one component of an electronic device, such as to a BMU of a portable electronic device. In other embodiments, the first tab 112a is configured to be connected to the third tab 114a and the second tab 112b is configured to be connected to the fourth tab 114b to connect the first stack 106a and the second stack 106b in a parallel configuration. The first tab 112a and the fourth tab 114b can be configured to be connected to at least one component of an electronic device, such as to a BMU of a portable electronic device.

The enclosure 101 can have any shape or size, giving the battery pack 105 substantial form factor flexibility. For example, the enclosure 101 can be formed to fit within a prescribed area within a device, such as a portable electronic device. This form can include any number of sides, angles, and/or shapes to account for one or more other components within the device. However, any shape or size of the enclosure 101 is contemplated.

In embodiments, the enclosure 101 includes a flexible pouch. such as a pouch formed by folding a flexible sheet along a fold line. In some instances, the flexible sheet is made of aluminum with a polymer film, such as polypropylene. After the flexible sheet is folded, the flexible sheet can be sealed, for example, by applying heat along a side seal and along a terrace seal. The flexible pouch may be less than or equal to 120 microns thick to improve the packaging efficiency of the battery pack 105, the density of battery pack 105, or both.

In embodiments the enclosure 101 may be formed of a rigid material, such as a metal alloy which may, for example, include stainless steel, aluminum, aluminum alloy, or other sufficiently rigid materials as would be known by a person of ordinary skill in the art. The enclosure 101 can have a non-corrosive coating line the interior of the enclosure 101. The enclosure 101 can have a cylindrical shape, cuboid shape, prism shape, conical shape, pyramid shape, L-shape, combinations thereof, or some other shape.

FIG. 1D is a cross section view of a battery pack 107. The battery pack 107 can include a battery cell 106 and an enclosure 101 enclosing the battery cell 106. The battery pack 107 can include at least one insulator 108 dividing the battery cell 106 into a first stack 106a and a second stack 106b. As shown in the example of FIG. 1D, the least one insulator 108 can include a first insulator 108a that surrounds (e.g., is wrapped around) the first stack 106a and a second insulator 108b that surrounds (e.g., is wrapped around) the second stack 106b. The first stack 106a can be positioned substantially on top of the second stack 106b. The interior walls of the enclosure 101 can be further lined with insulating material.

The single insulating divider layer can include polyethylene (PE), polypropylene (PP), and/or a combination of PE and PP, such as PE/PP or PP/PE/PP. The at least one insulator 108 can include any polymer material that is chemically resistant to battery electrolytes, composite layers (e.g., polymer layers sandwiching a metal foil to add mechanical robustness), and/or polymer materials reinforced with metal laminate layers. For example, the single insulating divider layer can include a polypropylene (PP) separation film. The single insulating divider layer can be heat sealed with the enclosure 101, such as with an outer layer or wall of the enclosure 101, to provide a liquid tight barrier between the two chambers. The first chamber and the second chamber can each separately be filled with an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The first stack 106a and the second stack 106b can each include a cathode layer, an anode layer, and a separator layer disposed between the cathode layer and the anode layer. For example, the cathode layer can be an aluminum foil coated with a lithium compound (e.g., LiCoO2, LINCoMn, LiCoAl or LiMn2O4) and the anode layer can be a copper foil coated with carbon or graphite. The separator layer can include polyethylene (PE), polypropylene (PP), and/or a combination of PE and PP, such as PE/PP or PP/PE/PP.

The battery pack 107 can include a first pair of conductive tabs 112a-b extending from the first stack 106a through the enclosure 101. The first pair of conductive tabs 112a-b can include a first tab 112a coupled to the cathode layer of the first stack 106a and a second tab 112b coupled to the anode layer of the first stack 106a. The battery pack 107 can include a second pair of conductive tabs 114a-b extending from the second stack 106b through the enclosure 101. The second pair of conductive tabs 112a-b can include a third tab 114a coupled to the cathode layer of the second stack 106b and a fourth tab 114b coupled to the anode layer of the second stack 106b.

In embodiments, the first tab 112a and the fourth tab 114b can extend through the enclosure 101 such that the first tab 112a and the fourth tab 114b at least partially overlap and reside in substantially separate parallel planes external to the enclosure 101. As shown in the example of FIG. 1D, the first tab 112a can reside substantially on top of the fourth tab 114b. Likewise, the second tab 112b can reside substantially on top of the third tab 114a.

In embodiments, the first tab 112a is configured to be connected to the fourth tab 114b to connect the first stack 106a and the second stack 106b in a series configuration. The second tab 112b and the third tab 114a can be configured to be connected to at least one component of an electronic device, such as to a BMU of a portable electronic device. In other embodiments, the first tab 112a is configured to be connected to the third tab 114a and the second tab 112b is configured to be connected to the fourth tab 114b to connect the first stack 106a and the second stack 106b in a parallel configuration. The first tab 112a and the fourth tab 114b can be configured to be connected to at least one component of an electronic device, such as to a BMU of a portable electronic device.

The enclosure 101 can have any shape or size, giving the battery pack 107 substantial form factor flexibility. For example, the enclosure 101 can be formed to fit within a prescribed area within a device, such as a portable electronic device. This form can include any number of sides, angles, and/or shapes to account for one or more other components within the device. However, any shape or size of the enclosure 101 is contemplated.

In embodiments, the enclosure 101 includes a flexible pouch. such as a pouch formed by folding a flexible sheet along a fold line. In some instances, the flexible sheet is made of aluminum with a polymer film, such as polypropylene. After the flexible sheet is folded, the flexible sheet can be sealed, for example, by applying heat along a side seal and along a terrace seal. The flexible pouch may be less than or equal to 120 microns thick to improve the packaging efficiency of the battery pack 107, the density of battery pack 107, or both.

In embodiments the enclosure 101 may be formed of a rigid material, such as a metal alloy which may, for example, include stainless steel, aluminum, aluminum alloy, or other sufficiently rigid materials as would be known by a person of ordinary skill in the art. The enclosure 101 can have a non-corrosive coating line the interior of the enclosure 101. The enclosure 101 can have a cylindrical shape, cuboid shape, prism shape, conical shape, pyramid shape, L-shape, combinations thereof, or some other shape.

FIG. 1E is a cross section view of a battery pack 109. The battery pack 109 can include the battery cell 106 and the enclosure 101 enclosing the battery cell 106. As shown in the example of FIG. 1E, the enclosure 101 itself can divide the battery cell 106 into the first stack 106a and the second stack 106b. The first stack 106a can be positioned substantially adjacent to the second stack 106b. The interior walls of the enclosure 101 can be lined with insulating material.

In embodiments, the walls of the enclosure 101 can form a first chamber housing the first stack 106a and a second chamber housing the second stack 106b. The first stack 106a and the second stack 106b can be connected via a connector 150. A gap between the first chamber and the second chamber can be filled with sealant 130 to provide a liquid tight barrier between the two chambers. The first chamber and the second chamber can each separately be filled with an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The first stack 106a and the second stack 106b can each include a cathode layer, an anode layer, and a separator layer disposed between the cathode layer and the anode layer. For example, the cathode layer can be an aluminum foil coated with a lithium compound (e.g., LiCoO2, LINCoMn, LiCoAl or LiMn2O4) and the anode layer can be a copper foil coated with carbon or graphite. The separator layer can include polyethylene (PE), polypropylene (PP), and/or a combination of PE and PP, such as PE/PP or PP/PE/PP.

The battery pack 109 can include a first pair of conductive tabs 112a-b extending from the first stack 106a through the enclosure 101. The first pair of conductive tabs 112a-b can include a first tab 112a coupled to the cathode layer of the first stack 106a and a second tab 112b coupled to the anode layer of the first stack 106a. The battery pack 109 can include a second pair of conductive tabs 114a-b extending from the second stack 106b through the enclosure 101. The second pair of conductive tabs 112a-b can include a third tab 114a coupled to the cathode layer of the second stack 106b and a fourth tab 114b coupled to the anode layer of the second stack 106b.

In embodiments, the first tab 112a and the fourth tab 114b can extend through the enclosure 101 such that the first tab 112a and the fourth tab 114b both substantially reside in a single plane external to the enclosure.

In embodiments, the first tab 112a is configured to be connected to the fourth tab 114b to connect the first stack 106a and the second stack 106b in a series configuration. The second tab 112b and the third tab 114a can be configured to be connected to at least one component of an electronic device, such as to a BMU of a portable electronic device. In other embodiments, the first tab 112a is configured to be connected to the third tab 114a and the second tab 112b is configured to be connected to the fourth tab 114b to connect the first stack 106a and the second stack 106b in a parallel configuration. The first tab 112a and the fourth tab 114b can be configured to be connected to at least one component of an electronic device, such as to a BMU of a portable electronic device.

The enclosure 101 can have any shape or size, giving the battery pack 109 substantial form factor flexibility. For example, the enclosure 101 can be formed to fit within a prescribed area within a device, such as a portable electronic device. This form can include any number of sides, angles, and/or shapes to account for one or more other components within the device. However, any shape or size of the enclosure 101 is contemplated.

In embodiments, the enclosure 101 includes a flexible pouch. such as a pouch formed by folding a flexible sheet along a fold line. In some instances, the flexible sheet is made of aluminum with a polymer film, such as polypropylene. After the flexible sheet is folded, the flexible sheet can be sealed, for example, by applying heat along a side seal and along a terrace seal. The flexible pouch may be less than or equal to 120 microns thick to improve the packaging efficiency of the battery pack 109, the density of battery pack 109, or both.

In embodiments the enclosure 101 may be formed of a rigid material, such as a metal alloy which may, for example, include stainless steel, aluminum, aluminum alloy, or other sufficiently rigid materials as would be known by a person of ordinary skill in the art. The enclosure 101 can have a non-corrosive coating line the interior of the enclosure 101. The enclosure 101 can have a cylindrical shape, cuboid shape, prism shape, conical shape, pyramid shape, L-shape, combinations thereof, or some other shape.

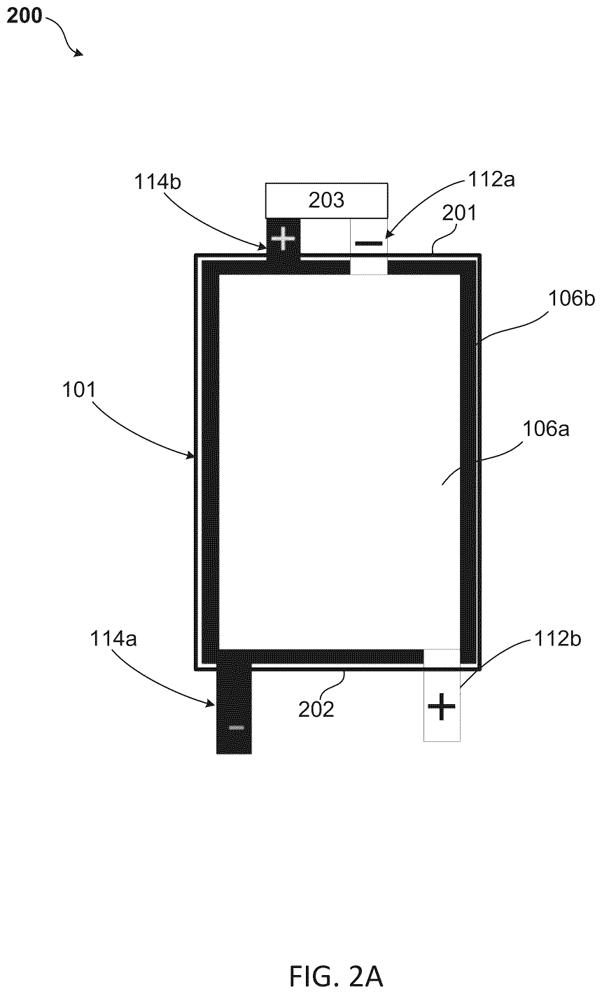

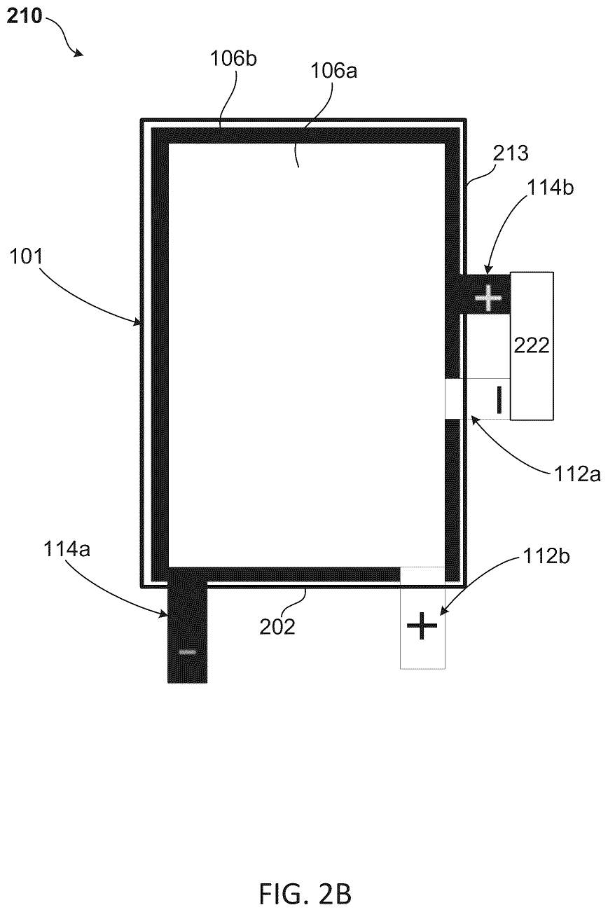

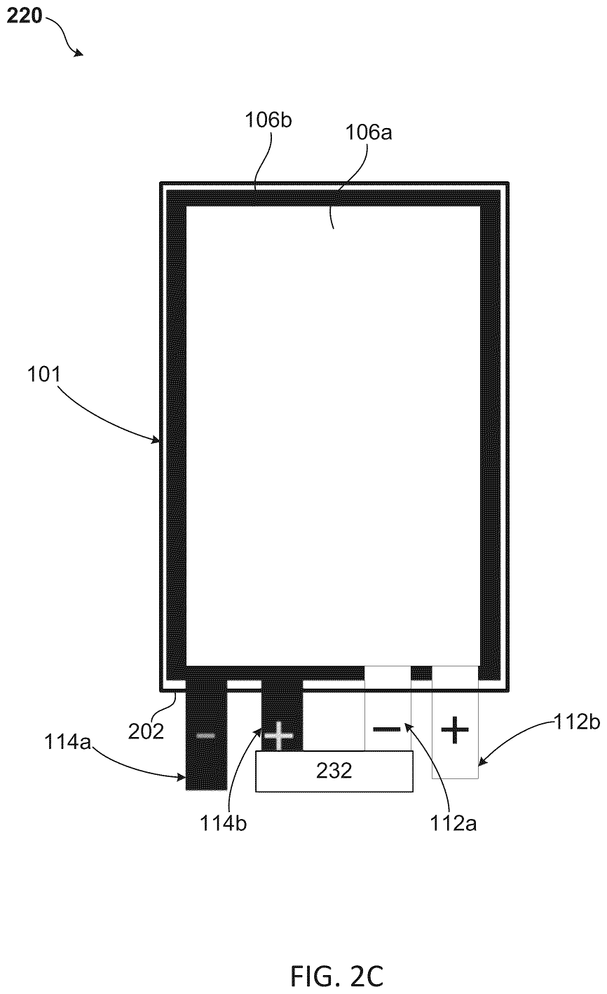

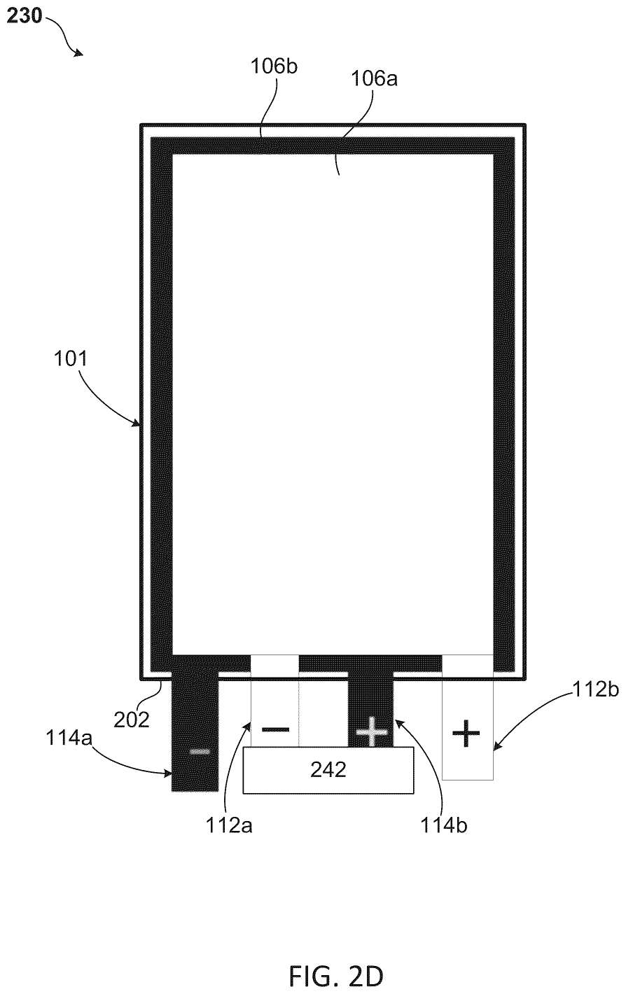

FIG. 2A is a top view of a battery pack 200. The battery pack 200 can include, for example, any of the battery packs described above with regard to FIGS. 1A-1E, including the battery pack 100, the battery pack 103, the battery pack 105, the battery pack 107, and/or the battery pack 109. The battery pack 200 can include the enclosure 101.

As described above with regard to FIGS. 1A-1E, the battery pack 200 can include the first pair of conductive tabs 112a-b extending from the first stack 106a through the enclosure 101 and the second pair of conductive tabs 114a-b extending from the second stack 106b through the enclosure 101. The first tab 112a and the fourth tab 114b can extend through a wall 201 of the enclosure 101. The first tab 112a and the fourth tab 114b can be connected via a connection 203 external to the enclosure 101. The second tab 112b and the third tab 114a can extend through a wall 202 of the enclosure 101. The wall 202 can be different from the first wall 201. The wall 202 can run parallel to the wall 201. The second tab 112b and the third tab 114a can be connected can be to at least one component of an electronic device, such as to a BMU of a portable electronic device.

FIG. 2B is a top view of a battery pack 210. The battery pack 210 can include, for example, any of the battery packs described above with regard to FIGS. 1A-1E, including the battery pack 100, the battery pack 103, the battery pack 105, the battery pack 107, and/or the battery pack 109. The battery pack 210 can include the enclosure 101.

As described above with regard to FIGS. 1A-1E, the battery pack 210 can include the first pair of conductive tabs 112a-b extending from the first stack 106a through the enclosure 101 and the second pair of conductive tabs 114a-b extending from the second stack 106b through the enclosure 101. The first tab 112a and the fourth tab 114b can extend through a wall 213 of the enclosure 101. The first tab 112a and the fourth tab 114b can be connected via a connection 222 external to the enclosure 101. The second tab 112b and the third tab 114a can extend through the wall 202 of the enclosure 101. The wall 213 can be different from the wall 202. The wall 213 can run perpendicular to the wall 202. The second tab 112b and the third tab 114a can be connected can be to at least one component of an electronic device, such as to a BMU of a portable electronic device.

FIG. 2C is a top view of a battery pack 220. The battery pack 220 can include, for example, any of the battery packs described above with regard to FIGS. 1A-1E, including the battery pack 100, the battery pack 103, the battery pack 105, the battery pack 107, and/or the battery pack 109. The battery pack 220 can include the enclosure 101.

As described above with regard to FIGS. 1A-1E, the battery pack 220 can include the first pair of conductive tabs 112a-b extending from the first stack 106a through the enclosure 101 and the second pair of conductive tabs 114a-b extending from the second stack 106b through the enclosure 101. The first tab 112a, the second tab 112b, the third tab 114a, and the fourth tab 114b can all extend through the wall 202 of the enclosure 101 such that the first tab 112a is positioned in between the second tab 112b and the fourth tab 114b. The first tab 112a and the fourth tab 114b can be connected via a connection 232 external to the enclosure 101. The second tab 112b and the third tab 114a can be connected can be to at least one component of an electronic device, such as to a BMU of a portable electronic device.

FIG. 2D is a top view of a battery pack 230. The battery pack 230 can include, for example, any of the battery packs described above with regard to FIGS. 1A-1E, including the battery pack 100, the battery pack 103, the battery pack 105, the battery pack 107, and/or the battery pack 109. The battery pack 230 can include the enclosure 101.

As described above with regard to FIGS. 1A-1E, the battery pack 230 can include the first pair of conductive tabs 112a-b extending from the first stack 106a through the enclosure 101 and the second pair of conductive tabs 114a-b extending from the second stack 106b through the enclosure 101. The first tab 112a, the second tab 112b, the third tab 114a, and the fourth tab 114b can all extend through the wall 202 of the enclosure 101 such that the first tab 112a is positioned in between the third tab 114a and the fourth tab 114b. The first tab 112a and the fourth tab 114b can be connected via a connection 242 external to the enclosure 101. The second tab 112b and the third tab 114a can be connected can be to at least one component of an electronic device, such as to a BMU of a portable electronic device.

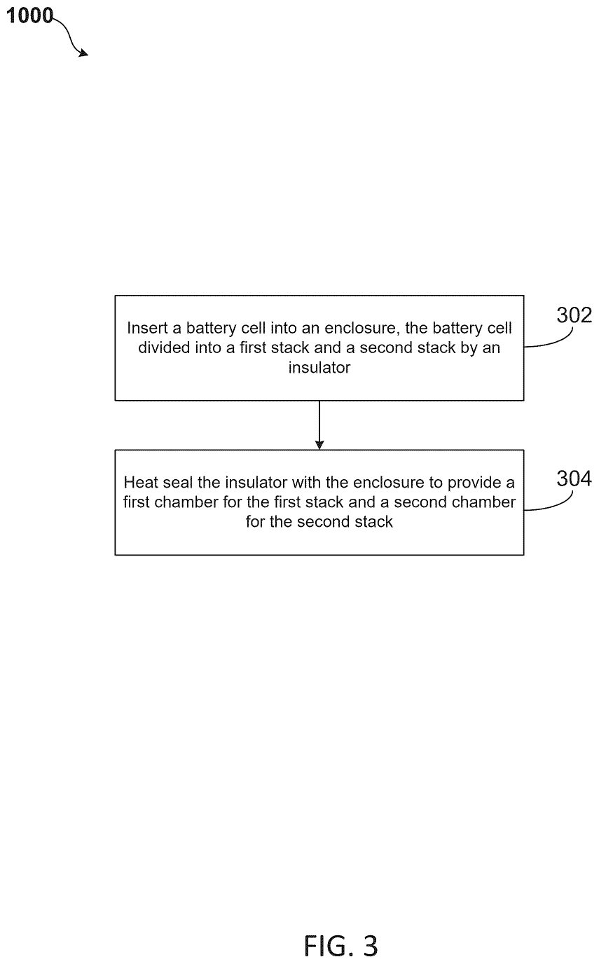

FIG. 3 illustrates an example method 300 for manufacturing a battery pack including a single battery cell having multiple stacks in accordance with various aspects of the subject technology. The method 300 can be used for manufacturing, for example, any of the battery packs described above with regard to FIGS. 1A-1E or FIGS. 2A-D, including the battery pack 100, the battery pack 103, the battery pack 105, the battery pack 107, the battery pack 109, the battery pack 200, the battery pack 210, the battery pack 220, and/or the battery pack 230. It should be understood that, for any process discussed herein, there can be additional, fewer, or alternative steps performed in similar or alternative orders, or in parallel, within the scope of the various embodiments unless otherwise stated.

At operation 302, the battery cell 106 is inserted into the enclosure 101. The battery cell 106 can be divided into a first stack 106a and a second stack 106b. The at least one insulator 108 can divide the battery cell 106 into the first stack 106a and the second stack 106b. The at least one insulator 108 can include polyethylene (PE), polypropylene (PP), and/or a combination of PE and PP, such as PE/PP or PP/PE/PP. The at least one insulator 108 can include any polymer material that is chemically resistant to battery electrolytes, composite layers (e.g., polymer layers sandwiching a metal foil to add mechanical robustness), and/or polymer materials reinforced with metal laminate layers. The enclosure 101 can similarly include polyethylene (PE), polypropylene (PP), and/or a combination of PE and PP, such as PE/PP or PP/PE/PP.

At operation 304, the at least one insulator 108 can be heat sealed with the enclosure 101. Heat sealing the at least one insulator 108 with the enclosure 101 can provide a first chamber for the first stack and a second chamber for the second stack. For example, the at least one insulator 108 can be heat sealed with the enclosure 101, such as with an outer layer or wall of the enclosure 101, to provide a liquid tight barrier between the two chambers. The first chamber and the second chamber can each separately be filled with an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

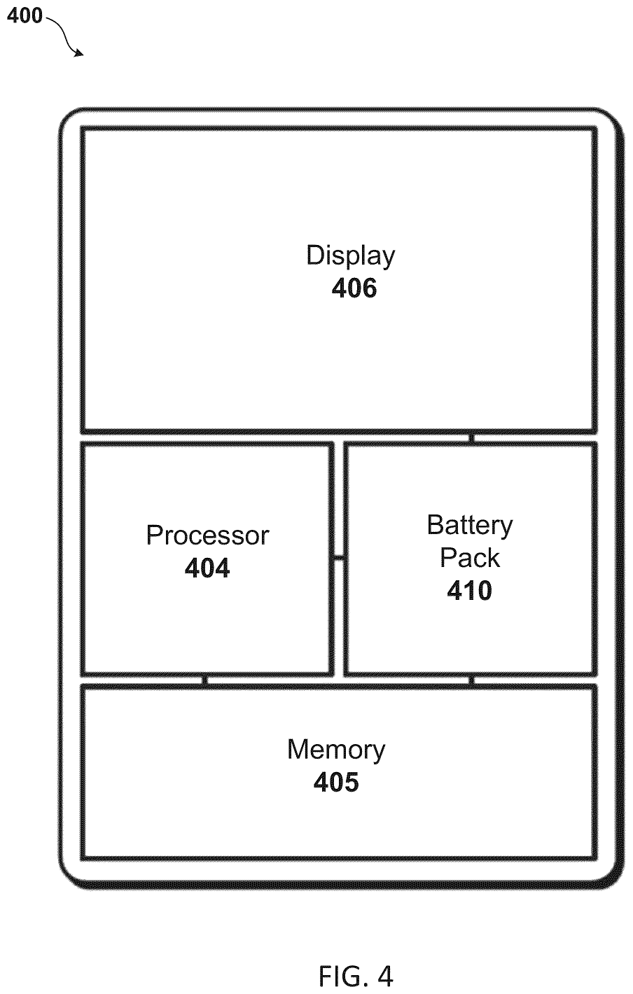

FIG. 4 illustrates a portable electronic device 400, in accordance with various aspects of the subject technology. The portable electronic device 400 includes a processor 404, a memory 405, and a display 406, which are all powered by a battery pack 410. Portable electronic device 400 may correspond to a laptop computer, tablet computer, mobile phone, personal digital assistant (PDA), digital music player, watch, and wearable device, and/or other type of battery-powered electronic device.

The battery pack 410 can include a single battery cell having multiple stacks. The battery pack 410 can include, for example, any of the battery packs described above with regard to FIGS. 1A-1E, including the battery pack 100, the battery pack 103, the battery pack 105, the battery pack 107, and/or the battery pack 109. The battery pack 410 can include, for example, any of the battery packs described above with regard to FIGS. 2A-2D, including the battery pack 200, the battery pack 210, the battery pack 220, and/or the battery pack 230.

While the battery cell 106 is described herein as being divided into a first stack 106a and a second stack 106b, it should be appreciated that the battery cell 106 can alternatively include two separate jelly roll structures (instead of stacks). Each of the jelly roll structures can include a plurality of layers wound to form a jelly roll. The plurality of layers can include a cathode with an active coating, a separator, and an anode with an active coating.

The term “substantially” used throughout this Specification is used to describe and account for small fluctuations. For example, it can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

The battery packs, battery assemblies, and various non-limiting components and embodiments as described herein can be used with various electronic devices. Such electronic devices can be any electronic devices known in the art. For example, the device can be a telephone, such as a mobile phone, and a land-line phone, or any communication device, such as a smart phone, including, for example an iPhone®, and an electronic email sending/receiving device. The battery cans, battery assemblies, and various non-limiting components and embodiments as described herein can be used in conjunction with a display, such as a digital display, a TV monitor, an electronic-book reader, a portable web-browser (e.g., iPad®), watch and a computer monitor. The device can also be an entertainment device, including a portable DVD player, conventional DVD player, Blue-Ray disk player, video game console, music player, such as a portable music player (e.g., iPod®), etc. Devices include control devices, such as those that control the streaming of images, videos, sounds (e.g., Apple TV®), or a remote control for a separate electronic device. The device can be a part of a computer or its accessories, laptop keyboard, laptop track pad, desktop keyboard, mouse, and speaker.

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A battery pack, comprising:
a battery cell;
an enclosure enclosing the battery cell;
at least one insulator dividing the battery cell into a first stack and a second stack, wherein the first stack and the second stack each comprise a cathode layer, an anode layer, and a separator layer disposed between the cathode layer and the anode layer;
a first pair of conductive tabs extending from the first stack through the enclosure, wherein the first pair of conductive tabs comprises a first tab coupled to the cathode layer of the first stack and a second tab coupled to the anode layer of the first stack; and
a second pair of conductive tabs extending from the second stack through the enclosure, wherein the second pair of conductive tabs comprises a third tab coupled to the cathode layer of the second stack and a fourth tab coupled to the anode layer of the second stack,
wherein the first tab is configured to be connected to the fourth tab to connect the first stack and the second stack in a series configuration, and wherein the second tab and the third tab are configured to be connected to at least one component of an electronic device.

2. The battery pack of claim 1, wherein the first tab, the second tab, the third tab, and the fourth tab extend through a first wall of the enclosure.

3. The battery pack of claim 1, wherein the first tab and the fourth tab extend through a first wall of the enclosure, and wherein the second tab and the third tab extend through a second wall of the enclosure.

4. The battery pack of claim 1, wherein the first tab and the fourth tab extend through the enclosure such that the first tab and the fourth tab at least partially overlap and reside in substantially separate parallel planes external to the enclosure.

5. The battery pack of claim 1, wherein the first tab and the fourth tab extend through the enclosure such that the first tab and the fourth tab both substantially reside in a single plane external to the enclosure.

6. The battery pack of claim 1, wherein the at least one insulator comprises an insulating divider that divides the enclosure into a first electrolyte-filled chamber housing the first stack and a second electrolyte-filled chamber housing the second stack.

7. The battery pack of claim 1, wherein the at least one insulator comprises a first insulating cover surrounding the first stack and a second insulating cover surrounding the second stack.

8. The battery pack of claim 1, wherein the enclosure comprises a flexible pouch.

9. The battery pack of claim 1, wherein the enclosure is a material comprising stainless steel, aluminum, an aluminum alloy, or a combination thereof.

10. The battery pack of claim 1, wherein the enclosure is substantially L-shaped.

11. A portable electronic device, comprising:
at least one component;
a battery management unit (BMU) configured to provide power from a battery pack to the at least one component; and
the battery pack comprising:
a battery cell;
an enclosure enclosing the battery cell;
at least one insulator dividing the battery cell into a first stack and a second stack, wherein the first stack and the second stack each comprise a cathode layer, an anode layer, and a separator layer disposed between the cathode layer and the anode layer;
a first pair of conductive tabs extending from the first stack through the enclosure, wherein the first pair of conductive tabs comprises a first tab coupled to the cathode layer of the first stack and a second tab coupled to the anode layer of the first stack; and
a second pair of conductive tabs extending from the second stack through the enclosure, wherein the second pair of conductive tabs comprises a third tab coupled to the cathode layer of the second stack and a fourth tab coupled to the anode layer of the second stack,
wherein the first tab is configured to be connected to the fourth tab to connect the first stack and the second stack in a series configuration, and wherein the second tab and the third tab are configured to be connected to the BMU to provide power from the battery pack to the at least one component.

12. The portable electronic device of claim 11, wherein the first tab, the second tab, the third tab, and the fourth tab extend through a first wall of the enclosure.

13. The portable electronic device of claim 11, wherein the first tab and the fourth tab extend through a first wall of the enclosure, and wherein the second tab and the third tab extend through a second wall of the enclosure.

14. The portable electronic device of claim 11, wherein the first tab and the fourth tab extend through the enclosure such that the first tab and the fourth tab at least partially overlap and reside in substantially separate parallel planes external to the enclosure.

15. The portable electronic device of claim 11, wherein the first tab and the fourth tab extend through the enclosure such that the first tab and the fourth tab both substantially reside in a single plane external to the enclosure.

16. The portable electronic device of claim 11, wherein the at least one insulator comprises an insulating divider that divides the enclosure into a first electrolyte-filled chamber housing the first stack and a second electrolyte-filled chamber housing the second stack.

17. The portable electronic device of claim 11, wherein the at least one insulator comprises a first insulating cover surrounding the first stack and a second insulating cover surrounding the second stack.

18. The portable electronic device of claim 11, wherein the enclosure comprises a flexible pouch.

19. The portable electronic device of claim 11, wherein the enclosure is a material comprising stainless steel, aluminum, an aluminum alloy, or a combination thereof.

20. The portable electronic device of claim 11, wherein the enclosure is substantially L-shaped.
